(19) United States
(12) Patent Application Publication
(10) Pub. No.: US 2016/0156784 A1
(43) Pub. Date: Jun. 2, 2016

(54) DYNAMIC TELEPHONE NUMBER ALLOCATION MANAGEMENT

(71) Applicant: ETHRIX LTD., Tel-Aviv (IL)

(72) Inventors: Avey GABRIELLI, Tel-Aviv (IL); Shaul WILENSKI, Tel-Aviv (IL); Avraham KADOSH, Herzlia (IL)

(21) Appl. No.: 14/904,962

(22) PCT Filed: Aug. 27, 2013
(86) PCT No.: PCT/IL13/50726

§ 371 Date: Jan. 14, 2016

Related U.S. Application Data
(60) Provisional application No. 61/846,026, filed on Jul. 14, 2013.

(51) Int. Cl. H04M 7/00

(52) U.S. Cl. CPC H04M 7/0075

(57) ABSTRACT

A method of routing a call to a selected target entity. The method comprises receiving, via a computer network, requests for a telephone number of a target entity having a contact telephone number, each the request being submitted by another of users using one of a plurality of client terminals displaying digital content object indicative of the target entity, allocating in response to each one of the requests a different dynamic telephone number from a pool of dynamic telephone numbers for a telephonic communication with the target entity and forwarding the allocated dynamic telephone number to be separately presented by a respective client terminal of the client terminals, receiving, via a telephone network, telephonic calls each designating a different dynamic telephone number of the pool, and automatically routing each one of the telephonic calls to the target entity using the contact telephone number.

### BACKGROUND

The present invention, in some embodiments thereof, relates to call routing and, more specifically, but not exclusively, to management of allocation of dynamic telephone numbers to a plurality of different callers.

Present day telecommunication carriers, such as AT&T, offer subscribers the opportunity to place calls from any terminal to a called party only of the charges for the call are associated with the used terminal or with a particular account number maintained by the carrier in the subscriber's name. When a subscriber is interested to bill a particular account for a call, the subscriber must enter identification information, such as a calling card number, usually by entering the appropriate digits through the key pad of the telephone. Usually, to access the carrier that maintains the particular account, the subscriber dials a special number (i.e., an access number) to reach the calling card carrier. For example, a subscriber that maintains a calling card account with AT&T can access AT&T from any telephone by dialing 1-800 CALL-ATT. While this particular access number is relatively easy to dial, calling card holders occasionally mis-dial access numbers, identification information, and/or Dual-Tone Multi-Frequency (DTMF) call routing signals, causing frustration.

Known solution is providing a subscriber with applications having the capability of automatically generating DTMF signal sequences. The DTMF signal sequences correspond to access telephone numbers, subscriber's personal identification code and/or DTMF routing signals.

During the last years, the number of people who use classified advertisements websites, such as Craigslist™ and Ebay™, has increased. People use these websites for posting advertisements for jobs, housing, personals, used items for sale, items wanted for purchase, services, community, gigs, résumés, and discussion forums.

When using a classified advertisement, a contact number has to be provided. This exposes the publisher to unwanted phone calls or text messages, for example from advertisers. One solution for the publisher is to use confidential phone services such as inumbr.com that provide a alias number that can be posted instead of his real contact number. Other solutions for requires from the dialer to provide DTMF data.

### SUMMARY

According to some embodiments of the present invention, there is provided a method of controlling a dynamic voice channel provided via a telephonic network. The method comprises displaying a digital content object associated with a telephone network based voice service to a user, forwarding, via a computer network, a temporal telephone number of the telephone network based voice service to the user, receiving, via a telephone network, a telephonic call request designating the temporal telephone number, automatically routing the telephonic call request to establish a dynamic voice channel between the caller and the telephone network based voice service via the telephone network, receiving at least one user selection from the digital content object via the computer network, and controlling content provided via the dynamic voice channel according to the at least one user selection.

Optionally, the controlling comprises receiving a plurality of transmission control protocol internet protocol (TCP IP) messages from the digital content object.

According to some embodiments of the present invention, there is provided a method of routing a call to a selected target entity. The method comprises receiving, via a computer network, a plurality of requests for a telephone number of a target entity having a contact telephone number, each the request being submitted by another of a plurality of users using one of a plurality of client terminals displaying digital content object associated with the target entity, allocating in response to each one of the plurality of requests a different dynamic telephone number from a pool of a plurality of dynamic telephone numbers for a telephonic communication with the target entity and forwarding the allocated dynamic telephone number to be separately presented by a respective client terminal of the plurality of client terminals, receiving, via a telephone network, a plurality of telephonic calls each designating a different dynamic telephone number of the pool, and automatically routing each one of the plurality of telephonic calls to the target entity using the contact telephone number.

Optionally, the digital content object is used by the plurality of users to control respective telephonic call of the plurality of telephonic calls.

Optionally, the allocating further comprises temporarily allocating the different dynamic telephone number for an allocation period of less than 24 hours, wherein the routing is performed if respective the telephonic call being received during the allocation period.

Optionally, the allocating further comprises allocating the different dynamic telephone number for an allocation period of less than 24 hours.

Optionally, the allocating is made for a period of less than one hour.

Optionally, the method further comprises allocating the different dynamic telephone number for an additional telephonic communication with an additional user in response to an additional request, the additional telephonic communication is between the additional user and an additional target entity having a different contact telephone number.

More optionally, the allocating further comprises for each one of the plurality of requests: extracting a calling number identification (caller ID) from a respective the request, associating a respective the dynamic telephone number and the caller ID, identifying an additional telephonic call with the caller ID and designating the respective dynamic telephone number, and routing the additional telephonic call to the target entity using the contact telephone number.

Optionally, the method further comprises presenting a plurality of graphical user interfaces (GUIs) each on another of the plurality of client terminals and in association with the digital content object. The GUIs are used for submitting the plurality of requests by the plurality of users. The GUIs are used for presenting the plurality of dynamic telephone numbers.

Optionally, the method further comprises: extracting a calling number identification (caller ID) from a respective the request, associating the caller ID with the respective request, selecting promotional content according to the digital content object, and forwarding the promotional content to an address selected using the caller ID.

Optionally, the plurality of dynamic telephone numbers comprises a plurality of billing telephone numbers (BTN).

Optionally, the digital content object does not include the contact telephone number.

More optionally, the routing is performed by an interactive voice response (IVR) platform.

Optionally, the digital content object is posted by an additional user, the digital content object is presented as an online classified personal advertisement, further comprising receiving the contact telephone number from the additional user via the computer network during a classified personal advertisement posting process.

Optionally, the digital content object comprises promotional content pertaining to a voice service; the target entity is a terminal of the voice service.

Optionally, the method further comprises logging a charge for each one of the plurality of telephonic calls.

Optionally, the method further comprises managing an allocation of the plurality of dynamic telephone numbers for presentation in association with a plurality of digital content objects.

More optionally, a ratio between a number of the dynamic telephone and a number of the plurality of digital content objects is less than 1:200.

More optionally, a ratio between a number of the dynamic telephone and a number of the plurality of digital content objects is less than 1:50.

According to some embodiments of the present invention, there is provided a system for routing calls. The system comprises an application module which receives, via a computer network, a plurality of telephone number requests submitted by a plurality of users via a plurality of different client terminals, each one of the plurality of telephone number requests is made for a contact telephone number of a target entity and in response to the presentation of digital content object describing a service or a product provided by the target entity, a dynamic call routing unit which allocates, in response to the plurality of telephone number requests, a plurality of different dynamic telephone numbers from a pool of a plurality of dynamic telephone numbers, each the different dynamic telephone number is allocated to establish a telephonic communication between a different user from the plurality of users and the target entity, the dynamic call routing unit forwards, via the computer network, the allocated dynamic telephone numbers to be presented by respective the client terminals, and an interactive voice response (IVR) platform which receives, via a telephone network, a plurality of telephonic calls each designating another of the plurality of different dynamic telephone numbers and routes the plurality of telephonic calls according to the allocation to the target entity using the contact telephone number.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a process for providing a caller with a dynamic telephone number that allows the caller to use the dynamic telephone number for contacting a requested target entity, according to some embodiments of the present invention;

FIG. 2 is a schematic illustration of a dynamic call routing system for allocating dynamic telephone number(s) to caller(s) and a number of network nodes with which it communicates during an allocation session, according to some embodiments of the present invention;

FIG. 3 depicts a classified personal advertisement that includes a graphical user interface which sends a request for a telephone number, according to some embodiments of the present invention;

FIG. 4 depicts the classified personal advertisement of FIG. 3 with a presentation of a dynamic telephone number which has been allocated in response to a related request, according to some embodiments of the present invention;

FIG. 5 is a schematic sequence chart depicting communication between the application server, the dynamic call routing unit and the repository of a system according to some embodiments of the present invention;

FIG. 6 depicts a sequence chart depicting communication between, the interactive voice response platform, the dynamic call routing unit of a system according to some embodiments of the present invention; and

FIG. 7 depicts an exemplary sequence flow of messages (i.e. requests and data messages), according to some embodiments of the present invention.

### DETAILED DESCRIPTION

The present invention, in some embodiments thereof, relates to call routing and, more specifically, but not exclusively, to management of allocation of dynamic telephone numbers to a plurality of different callers.

According to some embodiments of the present invention, there are methods and systems of managing calls of different users to a target entity associated with certain digital content object, such as an online classified personal advertisement, a classified personal advertisement script, a voice service advertisement, a call service description, a voice content service that is provided via telephone network such as a public switched telephone network (PSTN) a content service and/or the like. The methods and systems associate dynamic telephone numbers, optionally, temporarily, with requests for a contact number of the target entity so that calls designated the dynamic telephone numbers are routed to by automated telephone call management node, such as an interactive voice response platform, to the contact number. This allows changing the dynamic telephone numbers which are provided to connect callers to the contact number, for example randomly, periodically, or conditionally. Optionally, the methods and systems routes calls based on caller identifiers which are extracted from the calls, associating between a caller, a dynamic telephone number allocated for the caller, and the contact number of the related target entity.

According to some embodiments of the present invention, the methods and systems allows a user who dials the dynamic telephone number to be played with a dynamic voice channel that is established via a telephonic network, such as the PSTN and to control the data played in the dynamic voice channel, by messages send via a computer network. The user's call is associated with the digital content object, which is optionally interactive, for instance an active webpage component and/or a graphical user interface that is presented in an online application. The association allows coordinating between the received messages and the played dynamic voice channel. The messages may be originated from the same client terminal that plays the dynamic voice channel, for example a Smartphone, and/or another client terminal, for example a laptop that is used by a user who listens to the dynamic voice channel via a telephone. The messages may be messages that includes instructions which effect the dynamic voice channel, for example instructions to change played content tracks (e.g. music, data, news, and language) and/or to change a voice level, a reading pace, a reading language and/or any adaptable characteristic of the content played in the dynamic voice channel and/or a adaptable technical characteristic of the dynamic voice channel.

In such embodiments the user can receive a voice service via a telephonic network without going through any registration process via the telephonic network, for example without being required to dial a DTMF sequence for routing the call to the requested service, without being required to dial her code or identification (ID) information, without being required to provide a telephone number, for instance for receiving an authentication code via an short message service (SMS), and/or the like. This voice service is provided via the telephonic network while the identification data of the user and/or his credentials and/or information about the digital content object he is interested in is acquired via a session that he manages via a computer network, such as the internet, via a peer to peer connection, and/or via transmission and reception of control protocol internet protocol (TCP IP) messages.

In use, the methods and systems optionally identify a contact number which is associated with a certain digital content object of a target entity (i.e. a person or a service), allocates, optionally temporarily, a dynamic telephone number to a user who accesses the certain digital content object, and routes a call designating the dynamic telephone number to the target entity, which may be a person or a telephone network based voice service, using the contact telephone number. The dynamic telephone number is optionally given back to a pool of contact telephone numbers after the routing has ended. The dynamic telephone number is associated with the digital content object so that any input provided via the digital content object is associated with the calls established via the telephone network.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

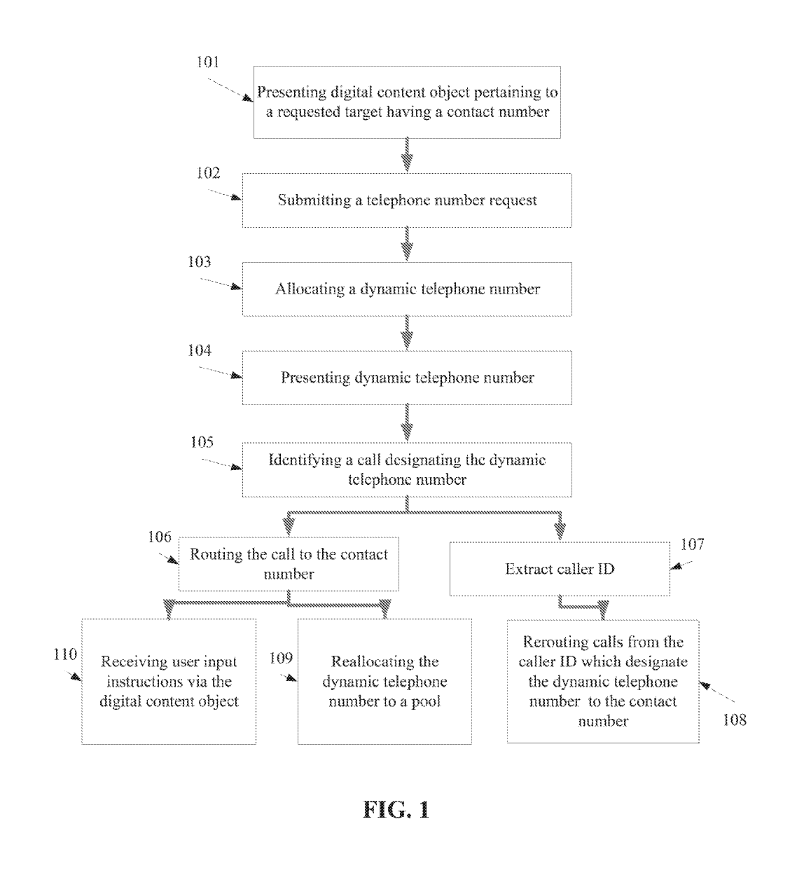

Reference is now made to FIG. 1, which is a flowchart of a process for providing a caller with a dynamic telephone number that allows the caller, optionally for a limited time, to use the dynamic telephone number for contacting a requested target entity, for example a callee, such as a person, or a telephone network based voice service, either automatic, for example news reading service, voice based game service, dating recoding playing service, and music playing service, or semi automatic, such as customer service center, and/or the like, according to some embodiments of the present invention. The dynamic telephone number is optionally allocated in response to a telephone number request. The request is optionally submitted in association with the presentation of digital content object related to the requested target entity. Optionally, once a dynamic telephone number is allocated to connect a certain caller to a certain target entity, it will be automatically allocated to connect the certain caller to the certain target entity in future sessions. In such a manner, if the caller remembers the dynamic telephone number which has been allocated thereto, she may use it in the future for the same purpose, either for a limited period and/or an unlimited period.

The digital content object may be any web accessible content, such as textual, audible, and/or visual content. For example, the digital content object includes a webpage, a HyperText Markup Language (HTML) document, an extensible markup language (XML), a finable form, a portable document format (PDF) document, a graphical user interface of an application, an open source interface definition (OSID) message, streamed media content and/or the like. The digital content object may be an interactive object, facilitating inputting user instructions during the voice call, for instance an asynchronous JavaScript and XML (AJAX) component and/or any GUI object.

The digital content object optionally includes or visibly associated with an advertisement for a service or a product provided by the requested target entity. For instance, the requested target entity may be a seller of a product and the digital content object may be an online classified personal advertisement. In this instance, the dynamic telephone number is provided to a requesting user, for example a browsing user who accesses a webpage with the digital content object, for example a call service description, an online classified personal advertisement, for example published in a classified advertising website such as Craigslist™, a user who uses an application which is installed in a client terminal, such as a Smartphone, and presented with the digital content object via the application. In another instance, the requested target entity may be a terminal of a voice service provider and the digital content object may be an advertisement of the voice service, for example vocal information service, adult voice service, web access call service and/or the like.

The dynamic telephone number is optionally temporally allocated from a pool of available dynamic telephone numbers and reallocated after being used. This allows using less dynamic telephone numbers than the number of services and/or web contact items which are being contacted by the dynamic telephone numbers, for example in a dynamic telephone number to digital content objects of 1:10, 1:50, 1:100, 1:200, 1:400 or intermediate or smaller ratio. The same dynamic telephone number optionally serves services of different types.

Optionally, after the allocation, the caller ID of the caller who requests for a call with the target entity using the dynamic telephone number is stored in association with the dynamic telephone number and the contact number of the target entity. In such embodiments, when the caller tries to call again to the target entity using the dynamic telephone number from the same device, he is automatically routed to the target entity, for example by an interactive voice response unit, for instance as described below. This allows users to redial the dynamic telephone number for further communication even if the dynamic telephone number was allocated to serve and route other requests from different callers and/or to different target entities. In such embodiments, when a call designating the dynamic telephone number is received from a caller having the stored caller ID, it is routed to the target entity which has been previously called by the same caller using the dynamic telephone number.

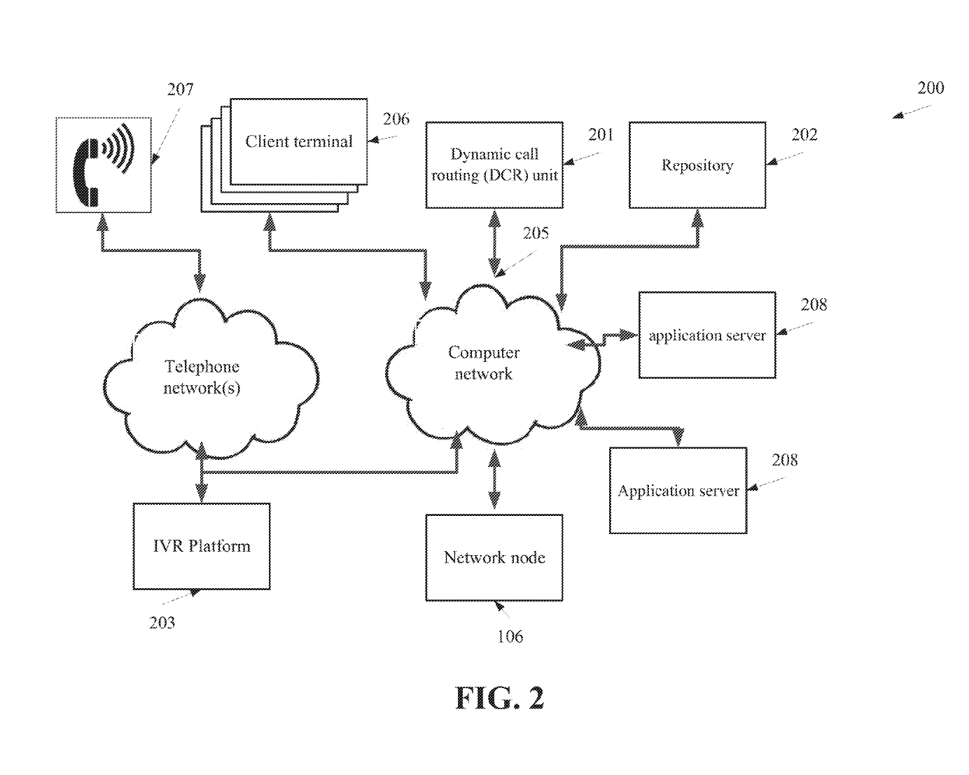

Reference is also made to FIG. 2, which is a schematic illustration of a dynamic call routing system 200 which includes a dynamic call routing (DCR) unit 201 for allocating dynamic telephone number(s) to caller(s) and a number of network nodes with which it communicates during an allocation session, according to some embodiments of the present invention. As depicted in FIG. 2, the DCR unit 201 may communicate with one or more application servers 207 via a computer network 205, receiving contact numbers of different target entities therefrom. As described below, the communication includes responding to a request originated from browsers or other applications used to via network accessible content of client terminals 206, such as laptops, Smartphones, tablets, smart glasses, and/or any other computing devices, via the computer network 205.

The DCR unit 201 may include and/or communicate with a repository 202 which may be hosted internally or externally. The DCR unit 201 may instruct routing of calls from caller(s) 207 performed by an automated telephone call management node, such as an interactive voice response (IVR) platform 203 connected to a telephone network, such as a cellular network or a PSTN, for example by sending allocation update messages thereto via the computer network 205. The IVR platform 203 may be referred to herein, for brevity, as IVR 203.

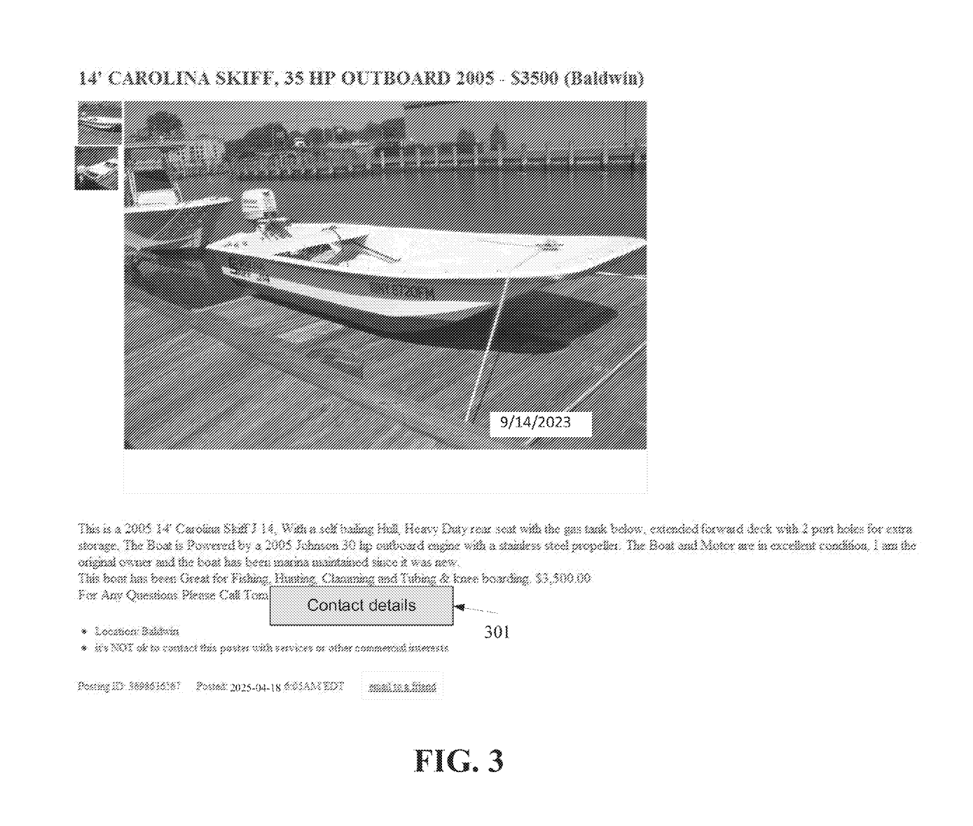

Reference is now made, once again, to FIG. 1. First, as shown at 101, a presentation of digital content object pertaining to a requested target entity having a contact telephone number is created. For example, the digital content object may be a classified personal advertisement and the contact telephone number is the contact number of a seller (i.e. a person) posting the classified personal advertisement. In another example, the digital content object includes web information, for example promotional content, related to a billed service, such as a voice service, and the contact telephone number is the call number of the voice service. In another example, the digital content object includes web information related to an access to a service that depends on calling a premium rate telephone number and the certain telephone number is the premium rate telephone number. In another example, the digital content object includes web information related to a competitor in a reality show and the certain telephone number is a telephone number for voting for the competitor. The created presentation is optionally information that is encoded to be rendered by a browser or a respective application. The presentation includes a graphical user interface (GUI), such as a button in a webpage, for instance a click and/or touch button presented in association with the digital content object. For example, FIG. 3 depicts a classified personal advertisement that includes such a GUI 301, according to some embodiments of the present invention. The presentation is optionally created based on a post uploaded during a posting session. The posting session requests for a contact number from the advertiser. In use, the contact number is not presented but rather remains in the repository.

As shown at 102, the presentation allows a user who is presented with the digital content object using the client terminal 206, for example via a browser or an application, to submit a telephone number request for a phone number of a target entity associated with the presented digital content object. For example, the user clicks and/or touches a button, such as 301 and a message indicative of the requested phone number is sent to the DCR unit 201 via a computer network.

It should be noted that the requesting user is not required to provide his phone number. This number is acquired via a caller ID analysis of a call designating the dynamic telephone number.

Now, as shown at 103, a dynamic telephone number is allocated to the telephone number request and/or to a future caller who submits the telephone number request, optionally for an allocation period of less than 48 hours, less than 24 hours, for example less than 12 hours, less than 6 hours, less than 3 hours, less than 1.5 hours, less than 45 minutes, less than 10 minutes or any intermediate or shorter period. The future caller may be identified according to a caller ID, for example as indicated below. For example, the dynamic telephone number is selected from a plurality of allocated numbers which are managed by the DCR unit 201 and stored in the repository 202. For example, the dynamic telephone number is a billing telephone number (BTN). In use, when a telephone request submitted by a user accessing a certain digital content object is identified, the DCR unit 201 receives a message and accesses the repository 202 for acquiring the dynamic telephone number.

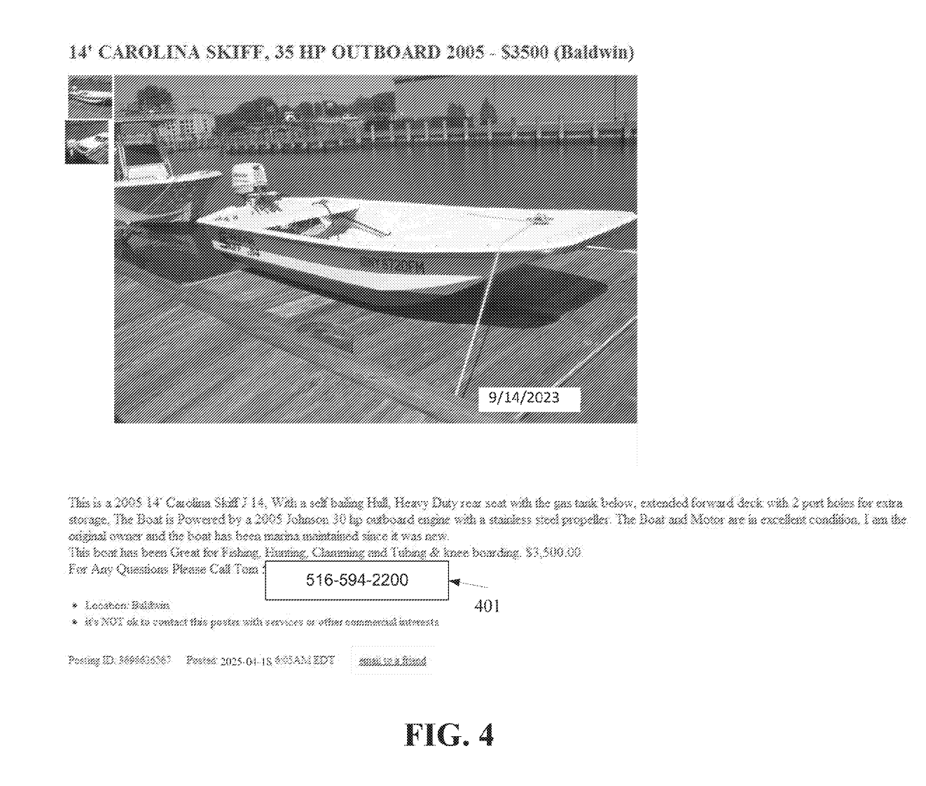

As shown at 104, the acquired dynamic telephone number is forwarded to be presented to the requesting user in response to the telephone number request. For example, as depicted in 401 of FIG. 4, the acquired dynamic telephone number is presented in response to a click or a touch of the button 301, for example instead of the button 301.

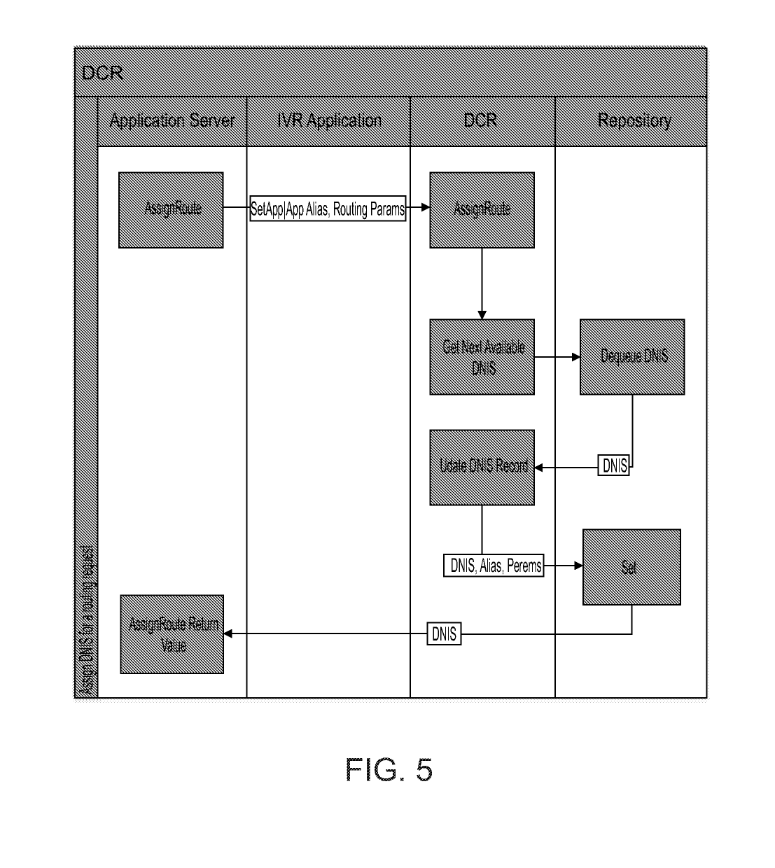

Optionally, the DCR unit 201 allocates a DNIS number from a pool of DNIS numbers which are stored in the repository 202. FIG. 5 is a schematic sequence chart depicting the communication between the application server 207, the DCR 201 and the repository 202.

Now, as shown at 105, a telephonic call received via a telephone network and designating the acquired dynamic telephone number is identified, for instance by the IVR platform 203, for example a call received via a cellular network or the PSTN.

This allows, for example when the telephonic call is received during the allocation period, as shown at 106, routing the identified telephonic call to the requested target entity using the respective contact number, for example from the repository.

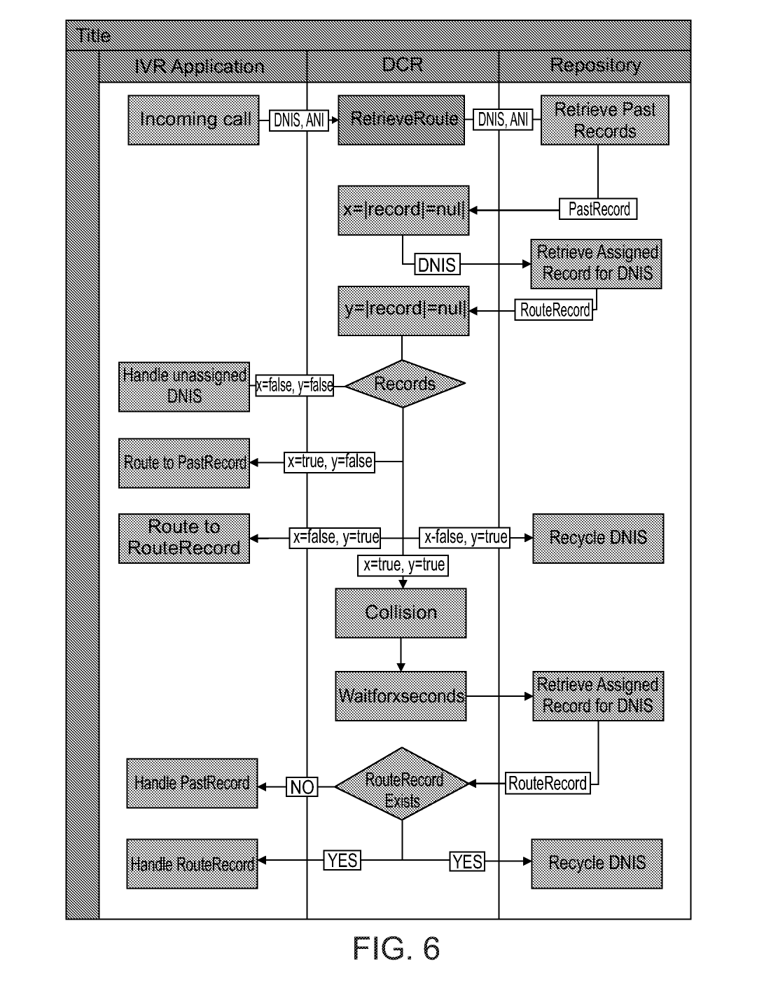

For example, FIG. 6 depicts a sequence chart depicting communication between, the IVR platform 203, the DCR unit 201, and the repository in which the dynamic telephone number which has been allocated to route calls to the contact number of the requested target entity is stored.

Routing the identified telephonic call to the requested target entity allows establishing a call with the target entity, for example a regular telephone network based phone call or a telephone network based voice service call during which a voice channel is played to the callee, for example a passive voice channel that cannot be controlled by the caller or a dynamic voice channel that can be controlled by the caller, as shown at 110, for instance by making selections and/or inputting data using a UI of the digital content object.

The user may access the digital content object via one client terminal, for instance a laptop or a tablet and place the call using a telephone or another client terminal such as a Smartphone. Alternatively, the user may user the same client terminal for both accessing the digital content object and placing a call using the dynamic telephone number.

When a dynamic voice channel is established, the caller is played with a dynamic voice channel that is established based on the above routing of the identified telephonic call to the requested target entity. The dynamic voice channel is established via the telephonic network and the data played in the dynamic voice channel is controlled by messages send via the computer network, using the digital content object. In these embodiments the digital content object is an interactive digital content object, for instance an active webpage component and/or a graphical user interface that is presented in an online application. The user's call is associated with the interactive digital content object as described above. The association allows coordinating between the received messages and the played dynamic voice channel The messages may be messages that includes instructions which effect the dynamic voice channel, for example instructions to change played content tracks (e.g. music, data, news, and language) and/or to change a voice level, a reading pace, a reading language and/or any adaptable characteristic of the content played in the dynamic voice channel and/or a adaptable technical characteristic of the dynamic voice channel. The messages may include instructions to the IVR, for example any instruction that could have been encoded as a DTMF signal or DTMF signal sequence. For instance the dynamic voice channel may be a news service that is optionally controlled by the caller, for example by user selections which are indicative of news topics. The user selections may be made from a menu that is presented by the digital content object. In another example, the dynamic voice channel is with a customer service center, such as service provider customer service, insurance company customer service and/or the like. The caller routes to the desired representative and/or service by inputting user selections which are indicative of the desired representative and/or service. For instance, the user selections may be made from a menu that is presented by the digital content object. Optionally, the user may use the digital content object to upload data such as scanned documents, images and/or the like. Optionally, the user may use the digital content object to input data such as ID codes, names and/or insurance required data and/or the like.

This voice service is provided via the telephonic network while the identification data of the user and/or his credentials and/or information about the digital content object he is interested in is acquired via a session that he manages via a computer network, such as the internet, via a peer to peer connection, and/or via transmission and reception of control protocol internet protocol (TCP IP) messages.

Optionally, as shown at 107, the caller ID of the requesting user is extracted from the request. For example, the routing unit 201, which optionally acts as a call router, routs the call to a caller ID module which identifies the caller (i.e. and not by automatic number identification (ANI) service), This allows enriching the call without requiring from the caller to enter an ANI or to dial a string of DTMF for detection.

In such embodiments, the when the dynamic telephone number is designated in a call from a caller having the caller ID, it is rerouted again to the same contact number, for instance as shown at 108. For example, the dynamic telephone number is associated with the caller ID of the requesting user for future calls identified by the caller ID. For example, the repository 202 stores a telephone number log for each contact number which has been routed to using the system 200. The telephone number log associates, for each call request, among a caller ID designated in the call request, the respective contact number of the target entity, and the allocated dynamic telephone number. In use, the caller ID of the requesting user may be matched with the caller IDs in the telephone number logs to identify the presence or absence of a match. If a match is found, the call is routed to reconnect the requesting party to the target entity (even though the dynamic telephone number the caller dialed is currently allocated to one or more other requests). In such embodiments, when a caller dials a dynamic telephone number previously allocated thereto for contacting a certain target entity of a certain contact number, it is routed to using the certain contact number to the certain target entity.

The caller ID is optionally used for authorizing an operation performed on the client terminal 206, for instance access to content. In such embodiments, the requesting user is charged for the time during which the call is maintained and/or for the call due to access to the digital content object.

For example, in FIG. 5 described below, an application server and/or an application installed on a client terminal contact the IVR platform to receive information about the status of the call with the requesting user, for example based on the identified caller ID. This allows the application server and/or the application to manage the access to content and/or to authorize requesting user accordingly.

Optionally, as shown at 107, the dynamic telephone number may be allocated to the telephone number request is now reallocated to the pool. This allows reallocating the dynamic telephone number to another telephone number request that is related to different digital content object, for example a different online classified personal advertisement. In such a manner, the usage in each dynamic telephone number is increased and the duration of the period during which this dynamic telephone number is relevant is reduced and/or minimized.

The above process allows allocating, for a limited time, dynamic telephone numbers to telephonic number requests associated with different digital content objects such as online classified personal advertisements. In such a manner, the actual number which allows contacting a person re the content items is not revealed, increasing the privacy of a publishing entity. Moreover, this allow using the DCR unit 201 to hurdle efforts of third party applications to reap online classified personal advertisements and/or any other telephone number associated (and optionally dependent) content from the operator of the DCR unit 201. As described above, the dynamic telephone numbers, which are provided in response to a request, may be associated with certain digital content objects for a limited time only and/or remain available as a reference to route a call to the respective contact number. Therefore, after the allocation period, these dynamic telephone numbers become unusable for a third party entity that copies digital content objects associated dynamic telephone numbers. Furthermore, as the dynamic telephone numbers are allocated for a limited time only, the same number may be used for contacting a plurality of different target entity entities per day and/or hour. This allows reducing the number of dynamic telephone numbers which are maintained for facilitating the above routing.

According to some embodiments of the present invention, the caller ID of the requesting user who uses the allocated dynamic telephone number is captured and optionally correlated with metadata gathered from his access to the digital content object pertaining to the requested target entity and/or from the submission of the request. In such embodiments, the caller ID of the requesting user may be correlated with personal data of the requesting user. The personal data may include subscriber information, for example acquired after the requesting user logs in the website that contain the related digital content object and/or from an application the requesting user uses for accessing the digital content object. The subscriber information may include history, demographic information, preferences and/or the like.

The personal data may include subscriber information such as subscriber browsing information, for example acquired from cookies installed in the client terminal from which the requesting user submitted the request. The personal data may include browsing information pertaining to the browsing session leading the requesting user to the digital content object, for example keywords used in a search which has directed the requesting user to the digital content object, a previous site visited by the requesting user, and/or the like.

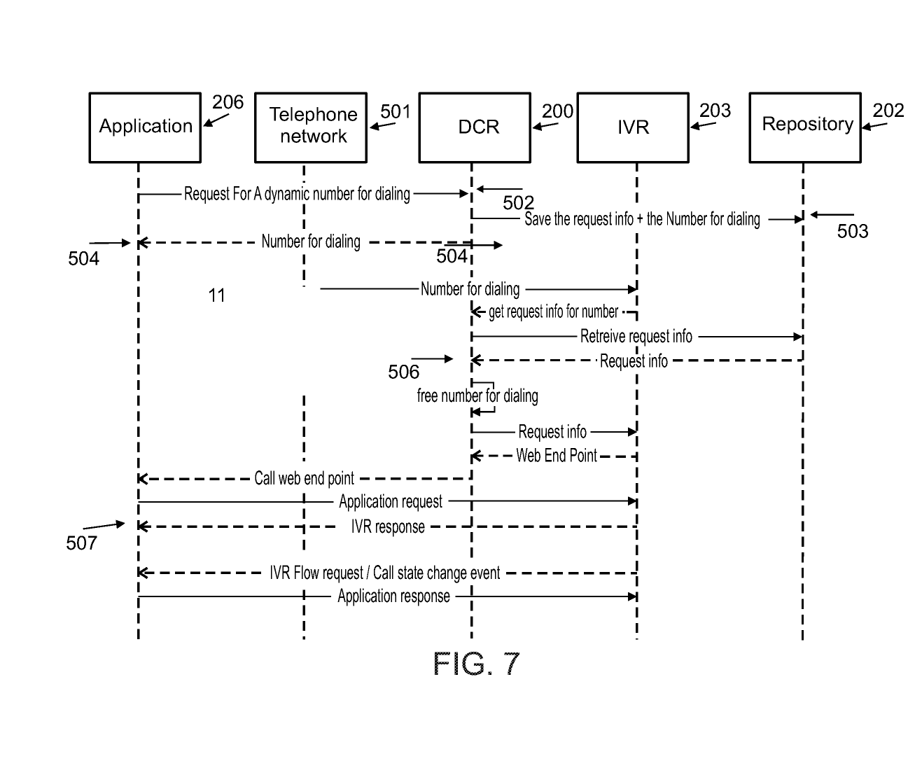

Reference is now made to FIG. 7 which depicts an exemplary flow of messages (i.e. requests and data messages), according to some embodiments of the present invention. The message flow is between an application (in client terminal(s) 206 and/or the server(s) 201) that manages the presentation of digital content object, a telephone network 501, such as fourth generation (4G), the IVR 203, and the repository 202.

The flow is optionally adapted to operate telephone network based voice service where dynamic telephone numbers are allocated to users who are interested to gain access to a dynamic voice service via a dynamic voice channel. In such embodiments, the digital content object is one of a plurality of optional services.

As depicted in 502, the DCR unit 201 receives a request for a telephone number, for example as described above. The DCR unit may be referred to herein, for brevity, as DCR. Then, as shown at 503, the DCR saves data from the request at the repository, for example the requested target entity. Now, as shown at 504, after the repository 202 is updated with the requested target entity, optionally with the number thereof (either in advance or with the request), the allocated dynamic telephone number is forwarded to be presented to requesting user. When certain calls from the telephone network are identified, for example received at the IVR 203 from a GSM and designating certain dynamic telephone numbers from a pool, they are forwarded to the DCR unit 201, for instance as depicted in 505. The DCR unit 201 now retrieves the request data from the repository 202, for example the contact number which has been provided in association with the digital content object, for instance the telephone number in a posted online classified personal advertisement.

As shown at 506, the DCR unit 201 uses the contact number to establish a call, for example using the telephone network 501. Optionally, the application authorizes an operation based on a verification that a call to the allocated dynamic telephone number was actually made, during a predefined time and/or from a certain caller ID.

Now a dynamic voice channel is established, allowing the caller to listen to content played by the telephone network based voice service via a dynamic voice channel that is established via a telephone network and controlled by a computer network. For example, an optional content service is authorized when a call, such as a PSTN or 4G call, is received and correlated with the requested service, for example as described above.

The above allows using a telephone network call, such as a normal telephone call, as a voice channel and using the digital content object, for example an application that is installed on a Smartphone, to control the voice channel The voice service is provided via the connected call correlated with data gathered in the application so that the user does not have to generate a unique DTMF sequence to control the voice channel but rather uses the application. For example, as shown at 507, the application 206 communicates with the IVR platform 203 by sending TCP IP messages.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the term a module, a processor, and a network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of controlling a dynamic voice channel provided via a telephonic network, comprising:
displaying a digital content object associated with a telephone network based voice service to a user;
forwarding, via a computer network, a temporal telephone number of said telephone network based voice service to said user;
receiving, via a telephone network, a telephonic call request designating said temporal telephone number;
automatically routing said telephonic call request to establish a dynamic voice channel between said caller and said telephone network based voice service via said telephone network;
receiving at least one user selection from said digital content object via said computer network; and
controlling content provided via said dynamic voice channel according to said at least one user selection.

2. The method of claim 1, wherein said controlling comprises receiving a plurality of transmission control protocol internet protocol (TCP IP) messages from said digital content object.

3. A method of routing a call to a selected target entity, comprising:
receiving, via a computer network, a plurality of requests for a telephone number of a target entity having a contact telephone number, each said request being submitted by another of a plurality of users using one of a plurality of client terminals displaying digital content object associated with said target entity;
allocating in response to each one of said plurality of requests a different dynamic telephone number from a pool of a plurality of dynamic telephone numbers for a telephonic communication with said target entity and forwarding said allocated dynamic telephone number to be separately presented by a respective client terminal of said plurality of client terminals;
receiving, via a telephone network, a plurality of telephonic calls each designating a different dynamic telephone number of said pool; and
automatically routing each one of said plurality of telephonic calls to said target entity using said contact telephone number.

4. The method of claim 3, wherein said digital content object is used by said plurality of users to control respective telephonic call of said plurality of telephonic calls.

5. The method of claim 3, wherein said allocating further comprises temporarily allocating said different dynamic telephone number for an allocation period of less than 24 hours; wherein said routing is performed if respective said telephonic call being received during said allocation period.

6. The method of claim 3, wherein said allocating further comprises allocating said different dynamic telephone number for an allocation period of less than 24 hours.

7. The method of claim 3, wherein said allocating is made for a period of less than one hour.

8. The method of claim 3, further comprising allocating said different dynamic telephone number for an additional telephonic communication with an additional user in response to an additional request, said additional telephonic communication is between said additional user and an additional target entity having a different contact telephone number.

9. The method of claim 8, wherein said allocating further comprises for each one of said plurality of requests:
extracting a calling number identification (caller ID from a respective said request,
associating a respective said dynamic telephone number and said caller ID,
identifying an additional telephonic call with said caller ID and designating said respective dynamic telephone number, and
routing said additional telephonic call to said target entity using said contact telephone number.

10. The method of claim 3, further comprising presenting a plurality of graphical user interfaces (GUIs) each on another of said plurality of client terminals and in association with said digital content object;
wherein said GUIs are used for submitting said plurality of requests by said plurality of users;
wherein GUIs are used for presenting said plurality of dynamic telephone numbers.

11. The method of claim 3, further comprising:
extracting a calling number identification (caller ID) from a respective said request,
associating said caller ID with said respective request,
selecting promotional content according to said digital content object,
forwarding said promotional content to an address selected using said caller ID.

12. The method of claim 3, wherein said plurality of dynamic telephone numbers comprises a plurality of billing telephone numbers (BTN).

13. The method of claim 3, wherein said digital content object does not include said contact telephone number.

14. The method of claim 13, wherein said routing is performed by an interactive voice response (IVR) platform.

15. The method of claim 3, wherein said digital content object is posted by an additional user, said digital content object is presented as an online classified personal advertisement; further comprising receiving said contact telephone number from said additional user via said computer network during a classified personal advertisement posting process.

16. The method of claim 3, wherein said digital content object comprises promotional content pertaining to a voice service, said target entity is a terminal of said voice service.

17. The method of claim 3, further comprising logging a charge for each one of said plurality of telephonic calls.

18. A computer readable medium comprising computer executable instructions adapted to perform the method of claim 3.

19. The method of claim 3, further comprising managing an allocation of said plurality of dynamic telephone numbers for presentation in association with a plurality of digital content objects.

20. The method of claim 19, wherein a ratio between a number of said dynamic telephone and a number of said plurality of digital content objects is less than 1:200.

21. The method of claim 19, wherein a ratio between a number of said dynamic telephone and a number of said plurality of digital content objects is less than 1:50.

22. A system for routing calls, comprising:
an application module which receives, via a computer network, a plurality of telephone number requests submitted by a plurality of users via a plurality of different client terminals, each one of said plurality of telephone number requests is made for a contact telephone number of a target entity and in response to the presentation of digital content object describing a service or a product provided by said target entity;
a dynamic call routing unit which allocates, in response to said plurality of telephone number requests, a plurality of different dynamic telephone numbers from a pool of a plurality of dynamic telephone numbers, each said different dynamic telephone number is allocated to establish a telephonic communication between a different user from said plurality of users and said target entity, said dynamic call routing unit forwards, via said computer network, said allocated dynamic telephone numbers to be presented by respective said client terminals; and
an interactive voice response (IVR) platform which receives, via a telephone network, a plurality of telephonic calls each designating another of said plurality of different dynamic telephone numbers and routes said plurality of telephonic calls according to said allocation to said target entity using said contact telephone number.

23. A computer program product for routing a call to a selected target entity, comprising:
a computer readable storage medium;
first program instructions to receive, via a computer network, a plurality of requests for a telephone number of a target entity having a contact telephone number, each said request being submitted by another user using one of a plurality of client terminals displaying digital content object associated with said target entity;
second program instructions to allocate in response to each one of said plurality of requests a different dynamic telephone number from a pool of a plurality of dynamic telephone numbers for a telephonic communication with said target entity and forwarding said allocated dynamic telephone number to be separately presented by a respective client terminal of said plurality of client terminals;
third program instructions to receive, via a telephone network, a plurality of telephonic calls each designating a different dynamic telephone number of said pool; and
fourth program instructions to route each one of said plurality of telephonic calls to said target entity using said contact telephone number; and
wherein said first, second, third, and fourth program instructions are stored on said computer readable storage medium.
